(19) United States
(12) Patent Application Publication
(10) Pub. No.: US 2022/0325741 A1
(43) Pub. Date: Oct. 13, 2022

(54) MECHANICAL CONNECTION COMPONENT WITH A PRESSURE INDICATOR

(71) Applicant: REVOTEC ZT GMBH, Wien (AT)

(72) Inventors: Michael REITERER, Wien (AT); Joachim MUIK, Wien (AT)

(21) Appl. No.: 17/611,045

(22) PCT Filed: May 11, 2020
(86) PCT No.: PCT/AT2020/060191

§ 371 Date: Nov. 12, 2021

(30) Foreign Application Priority Data
May 13, 2019 (AT) A 50427/2019

(51) Int. Cl. F16B 31/02; F16B 1/00; F16B 37/14

(52) U.S. Cl. CPC F16B 31/025; F16B 1/0071; F16B 37/14; F16B 2001/0035

(57) ABSTRACT

The invention relates to a mechanical connection component for connecting a first element (1) to a second element (2). The connection component can be brought from an untensioned position into a tensioned position by exerting a clamping force (F), wherein a pressure pin (7) with a head portion (8) is arranged in a recess of the connection component (5), and a pressure indicator (9) is arranged or can be arranged in the region of the head portion (8). The head portion (8) is arranged so as to exert pressure onto the pressure indicator (9) in the untensioned position of the connection component (5) and not exert any pressure onto the pressure indicator (9) or exert a reduced pressure in comparison to the untensioned position when the connection component (5) is in the tensioned position.

The present invention relates to a mechanical connecting component, such as a screw, a threaded rod or a bolt, having the features of the preamble of the independent patent claim. Mechanical connecting components are commonly used in the prior art for connecting two or more elements. The connecting component is inserted into clearances of the respective elements or passed through the clearances, whereupon the connecting component is subjected to a clamping force or a pretensioning force. This clamping force ensures a non-positive connection between the elements to be connected. The clamping force can be exerted, for example, by tightening a screw or a threaded nut.

In particular in applications that have to ensure connections over a long period of time, for example in connecting components for bridges, masts and supporting elements, loosening of the connection can occur over time. This can be the case in particular if the connected elements are subjected to strong dynamic load effects with the associated vibrations, such as in the case of supporting elements on railroad lines or on bridges subject to heavy traffic.

If there is a risk of loosening of the connecting components, regular checks are required to ensure that the connected components are securely fastened to one another. The check is usually carried out manually, wherein loosening can only be detected when the connection has already been completely loosened, i.e., for example, when a screw or clamping nut is completely loose. This is associated with the disadvantage that an appropriate number of connecting components must be provided in order to nevertheless enable secure fastening. In addition, the check described can often only be carried out with increased effort, since the corresponding connecting components may be positioned in places that are difficult to access.

It is therefore the task of the present invention to create a connecting component which overcomes the aforementioned disadvantages of the prior art and which preferably enables detection of the relaxation of the clamping force or the pretensioning force before the entire clamping effect has been lost. This would also make it possible to reduce the number of necessary connecting components.

These and other tasks are solved with a connecting component according to the invention.

Thus, the invention relates to a mechanical connecting component for connecting a first element to a second element by exerting a clamping force, comprising a first clamping region and a second clamping region, which is arranged at a distance from the first clamping region, wherein an expansion region is arranged between the first clamping region and the second clamping region. The expansion region can also be referred to as clamping length. The connecting component can also be configured to connect more than two elements to one another.

The invention provides that the connecting component can be moved from an unclamped position to a clamped position by the exertion of the clamping force, the length of the expansion region and, thus, the length of the connecting component increasing when the clamping force is exerted. Thus, in the unclamped position, the connecting component is shorter than in the clamped position.

According to the invention, an elongated recess extends in the interior of the connecting component, at least in the expansion region. A pressure pin, which comprises a head section and is connected to the connecting component at one end and not connected to the connecting component at its other end, is arranged at least partially inside this recess. Preferably, the pressure pin extends from the first clamping region at least to the second clamping region, i.e. over the entire expansion region. Preferably, the head section is arranged at that end of the pressure pin which is not connected to the connecting component.

A pressure indicator is arranged or at least can be arranged in the region of the head section of the pressure pin. The head section is positioned in such a way as to exert pressure on the pressure indicator in the unclamped position of the connecting component and to exert no pressure or a pressure which is reduced in comparison with the unclamped position on the pressure indicator in the clamped position of the connecting component.

In particular, the exertion of the clamping force can cause a substantially purely elastic deformation of the connecting component, especially of the expansion region. The clamping force is thus to be adapted in particular in such a way that it is substantially below the yield point of the material of the connecting component. Preferably, the clamping force is in a range greater than 10 kN, further preferably greater than 50 kN, if the connecting component is a bolt with a diameter of 20 mm. Those skilled in the art will adjust the clamping force accordingly based on the diameter of the bolt and the desired application.

The pressure pin is not connected to the connecting component, in particular in the expansion region and preferably also in the second clamping region. As a result, the pressure pin does not follow an elongation of the expansion region and a relative movement between the second clamping region and the head section of the pressure pin is allowed. The relative position between the first clamping region and the pressure pin remains substantially constant.

In the context of the present invention, in particular that region of a connecting component which expands when a clamping force is applied is referred to as expansion region. This clamping force can be applied in particular between the two clamping regions. Although the expansion region lies between the two clamping regions, it should be noted that the exact extension of the expansion region cannot usually be specified, as it usually transitions smoothly to the clamping regions.

Optionally, it is provided that the recess extends from the first clamping region to the second clamping region. It is optionally provided that the pressure pin extends from the first clamping region to the second clamping region, and in that one end of the pressure pin is connected to the connecting component in the first clamping region and is not connected to the connecting component in the second clamping region. Preferably, the pressure pin extends over the entire length of the expansion region. This way, a particularly high sensitivity is achieved, since the pressure pin covers the entire expansion region.

The head section can be designed in such a way that it presses against the pressure indicator, in particular when the expansion region is at its minimum elongation, i.e. in the unclamped state of the connecting component. Alternatively, the pressure indicator may be arranged on the head section and thus pressed against another element. Such a pressure indicator may be any material or element known to those skilled in the art indicating a pressure. Preferably, the pressure indicator indicates the pressure visually.

Optionally, the pressure indicator may comprise or be made of a piezochromic material. Piezochromic behavior is the property of a substance or material to change color when subjected to pressure. Preferably, this color change is reversible. Various piezochromic materials are known to those skilled in the art that can be used in the context of the present invention, for example piezochromic organic polymers, piezochromic minerals or piezochromic pigments.

Preferably, the piezochromic material is a piezochromic polymer composite, in particular comprising or consisting of a polymeric matrix material in which a piezochromic substance is contained.

Optionally, it is provided that a cover element is provided, which can be or is connected to an end region of the connecting component. The cover element may either be rigidly connected to the end region of the connecting component, or it may be able to be clipped thereon, screwed thereon or otherwise fastened thereto. For example, the cover element may be designed as a screw-on nut or a clip-on cap. In particular, the cover element may be designed such that it is attached only after the clamping force has been applied.

It may be provided that the pressure indicator is arranged in or on the cover element. Alternatively, it may be provided that the pressure indicator is arranged on the head section of the pressure pin. In both embodiments, when the clamping force decreases, i.e. when the length of the expansion region is reduced, the pressure pin presses on the cover element and generates a pressure on the pressure indicator.

The cover element is preferably designed to be flush with the connecting component. Optionally, it may be provided that the cover element is configured to be substantially flush with the connecting component, in particular when fully attached to the connecting component. In particular, the cover element may cover an open end of the recess of the connecting component in a flush manner so that it is pressed against the protruding pressure pin when attached to the clamped connecting component. If the cover element is fitted or screwed on after the clamping force has been applied, it is thus easy to check whether the clamping force corresponds to a suitable value.

If the cover element can be fastened to the end region, there is also the advantage that it can only be arranged thereon after the connecting component has been mounted. This avoids unnecessary load on the pressure indicator, especially since the pressure pin exerts pressure on the pressure indicator in the unclamped position of the connecting component. This results in the above-mentioned advantage that, when the cover element is fastened after the clamping force has been applied, an initial check of the properly executed tightening process, i.e. in particular the proper magnitude of the clamping force, of the connecting component can already be carried out.

Optionally, it is provided that the pressure indicator is covered with an at least partially transparent protective plate on the side facing away from the head section. Optionally, it is provided that the cover element has an at least partially transparent protective plate on the side facing away from the head section.

The protective plate can protect the pressure indicator from external influences, for example from water, oxygen, mechanical influences, or the like. Furthermore, the protective plate can mechanically stabilize the pressure indicator and prevent the head section of the pressure pin from piercing the pressure indicator. To allow a clear view of the pressure indicator, the protective plate is at least partially of transparent design, for example is an optical window made of glass or plastic. Alternatively, the protective plate can also be designed as a perforated plate. The protective plate may also be made of or comprise an elastic material so that a maximum permissible load on the pressure indicator is not exceeded. A viewing clearance in the cover element may optionally be filled with an elastic material, which is preferably transparent or translucent, wherein a filling with a greater thickness may also be referred to as protective plate.

Optionally, it is provided that the recess in the connecting component is arranged parallel to the longitudinal extension direction of the connecting component, preferably centrally along a central longitudinal axis of the connecting component.

Optionally, it is provided that the pressure pin is arranged parallel to the longitudinal extension direction of the connecting component, preferably centrally along a central longitudinal axis of the connecting component.

Optionally, it is provided that the pressure pin is substantially rigidly connected to the connecting component at its end opposite the head section by a retaining means. Preferably, the pressure pin is freely movable within the connecting component in all other regions.

Optionally, the retaining means may be a polymer material in which the end opposite the head section of the pressure member is embedded and/or molded.

The polymer material can thus be arranged in the recess of the connecting component, in particular only at the innermost section of the recess. The polymer material is in particular curable synthetic resin, for example epoxy or polyester. Preferably, the polymer material exhibits little or no volume change upon curing.

Optionally, the retaining means may be a magnetic retaining element, the pressure pin having a magnetic and/or a ferromagnetic material at least at its end opposite the head section.

This embodiment allows for reversible attachment of the pressure pin in the recess. The connection is enabled by the magnetic force between the magnetic retaining element and the pressure pin or the end of the pressure pin. The magnetic retaining element may comprise or be made of a magnetic and/or a ferromagnetic material.

Optionally, the connecting component may be made entirely of a ferromagnetic material, in which case the corresponding end of the pressure pin comprises a magnetic material.

Optionally, it is provided that the pressure pin has a tapered region, in particular a tip, at its end opposite the head section. This serves to improve the insertion of the pressure pin into the recess, which is particularly advantageous since the recess usually has a very small diameter in the range of less than 5 mm, preferably less than 2 mm. The recess can be made by any process suitable for forming such a recess, for example by drilling or by electrical discharge machining.

Optionally, the retaining means may be a mechanical clamping connection into which the end opposite the head section of the pressure member is rigidly clamped.

Optionally, it is provided that the clamping force is or can be generated by at least one clamping nut arranged in the second clamping region.

Optionally, it is provided that the first clamping region can be or is rigidly connected to the first element by bonding, welding and/or casting. This embodiment is particularly advantageous in case the first element is a solid material, for example a concrete body, which cannot be completely penetrated by the connecting component.

Optionally, it is provided that the connecting component has a projection and/or a fastening nut in the first clamping region for positive connection to the first element, so that the connecting component can be partially inserted into a clearance of the first element. This embodiment is particularly advantageous in case two elements with a small thickness, for example plates or beams, are to be connected to one another.

The invention further relates to an arrangement, comprising a connecting component according to the invention and a first element and a second element, wherein a clearance is provided in the first element or in the second element, which is suitable for passing through and/or inserting the connecting component.

Optionally, it is provided that the connecting component is arranged to be freely movable at least in the expansion region within the clearance.

In the context of the present invention, the expression “freely movable” means that a relative movement between the expansion region and an element is possible. Optionally, stabilizing elements, such as stabilizing bandages, may be provided to reduce friction between the element and the connecting component to some extent, thereby allowing elongation of the expansion region or increasing the expansion region.

The invention further relates to a system comprising a connecting component according to the invention and a pressure indicator. The invention also relates to a system comprising a connecting component according to the invention, a pressure indicator, and a cover element. Further features of the invention become apparent from the patent claims, the figures and the exemplary embodiments.

In the following, the invention will be discussed in detail with reference to exemplary embodiments. The exemplary embodiments merely show preferred variants of the invention, but are not intended to limit the scope of protection in any way. In the figures:

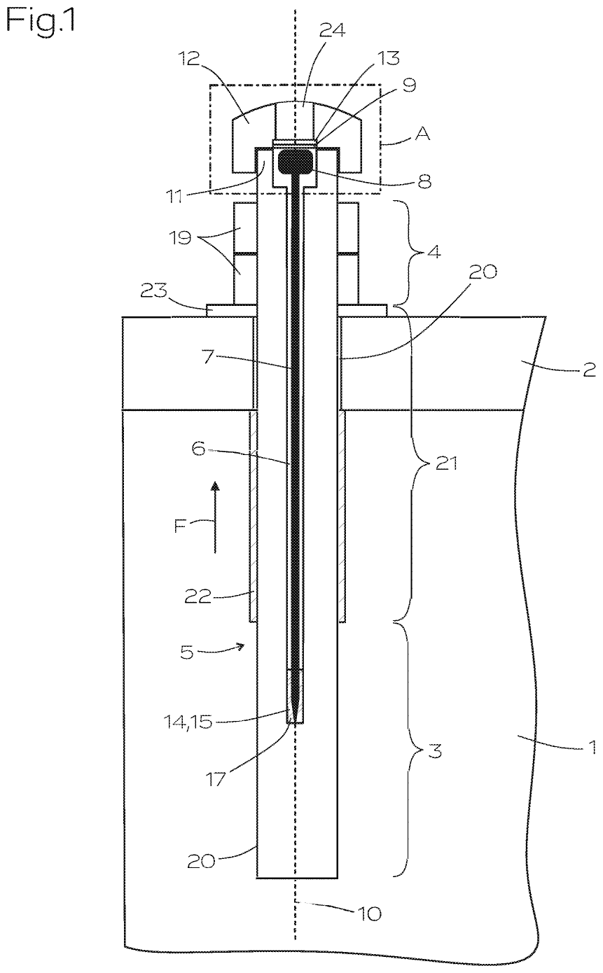

FIG. 1 shows a schematic view of a first exemplary embodiment of the invention;

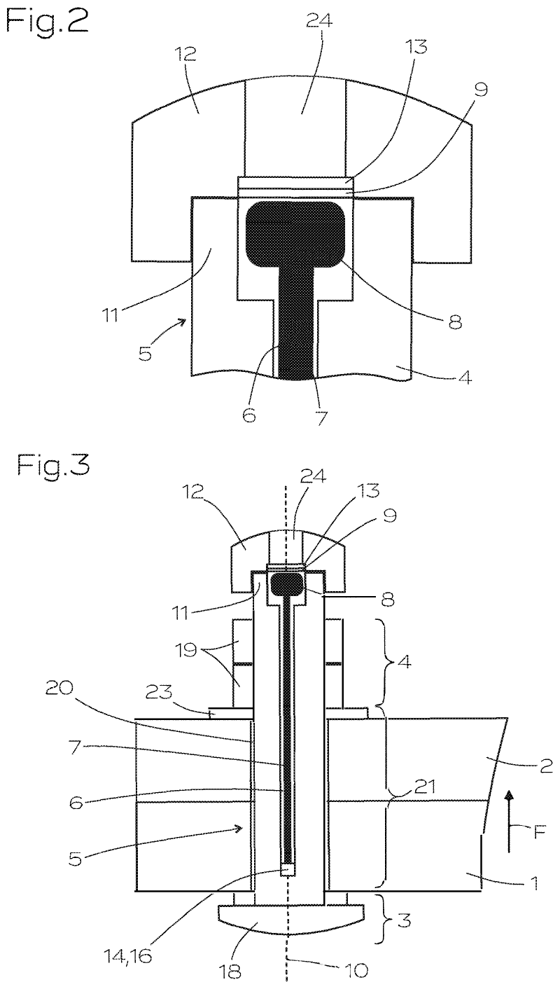

FIG. 2 shows a detailed view of a region of FIG. 1; and

FIG. 3 shows a schematic view of a second exemplary embodiment of the invention.

FIG. 1 shows a schematic view of a first exemplary embodiment of the invention, wherein the connecting component 5 is used to connect a first element 1 and a second element 2. In the present exemplary embodiment, the connecting component is a threaded rod.

In this exemplary embodiment, the first element 1 is a solid concrete body with a clearance 20 in the form of a bore, into which the connecting component 5 is inserted with its first clamping region 3 and part of the expansion region 21. In this exemplary embodiment, the expansion region 21 extends substantially in the region of the bandage 22, the height of the second element 2 and the height of the washer 23. The first clamping region 3 is bonded to the clearance 20 of the first element 1, so that the connecting component 5 is fixedly connected to the first element 1. The expansion region 21 is not fixedly connected to the clearance 20 of the first element 1. A bandage 22 is provided in the expansion region 21 to reduce friction between the element 1 and the connecting component 5 to a certain extent, thereby increasing the expansion region 21. The bandage 22 does not provide a substantial non-positive connection between the clearance 20 and the fastening bolt 5.

In other exemplary embodiments not shown, the bandage 22 may also be omitted, thereby rigidly connecting the connecting component 5 to the first element 1 over a larger region. As a result, the effective length of the expansion region 21 decreases and the first clamping region 3 increases.

The second element 2 in this embodiment is a steel plate which also has a clearance 20 in the form of a bore. The connecting component 5 extends completely through the clearance 20. A recess 6 is provided within the connecting component 5, which extends in the longitudinal extension direction 10 of the connecting component. A pressure pin 7, which has a widened head section 8 at one end, is arranged in the recess. At its other end, the pressure pin 7 has a tip 17, which serves to facilitate the insertion of the pressure pin 7 into the recess 6.

In the region of the tip 17, the pressure pin 7 is connected to the connecting component 5 via a retaining means 14. The retaining means 14 is made of a polymer material 15 which is introduced into the recess 6 in an uncured state and hardens there after positioning of the pressure pin 7, thereby fastening the pressure pin 7 in a substantially non-displaceable manner. The pressure pin 7 is fixedly connected to the connecting component 5 only in the region of one end, in this exemplary embodiment that end at which the tip 17 is arranged.

At the end of the connecting component 5 that is adjacent to the second clamping region 4, a cover element 12 is arranged that is designed as a screw-on cap nut. In its center, the cover element 12 has a pressure indicator 9 on the inside, which in this exemplary embodiment is designed as a foil made of a piezochromic polymer material. The pressure indicator 9 is colored blue when not pressurized, i.e. at atmospheric pressure, while it is colored red at an increased pressure, in particular at a pressure greater than 10 N/cm².

The pressure indicator 9 is covered by a protective plate 13 made of transparent plexiglass. In addition, a view clearance 24 is provided in the cover element 12 to allow a clear view of the pressure indicator 9 through the protective plate 13.

In FIG. 1, the cover element 12 is flush with the connecting component 5, in particular with the open end of the recess 6.

The pressure pin 7 has a suitable length such that, in the unclamped state of the fastening bolt 5, it projects about 0.2 mm beyond the end of the bolt 5. Therefore, when the cover element 12 is fully screwed on, the head section 8 exerts pressure on the pressure indicator 9. In this condition, the pressure indicator is colored red.

The clamping force F is generated by two clamping nuts 19. A washer 23 is arranged between the second element 2 and a clamping nut 19.

When the clamping nut 19 is tightened, i.e. when the clamping force F is increased, elongation of the expansion region 21 occurs, wherein the position of the head section 8 of the pressure pin 7 remains substantially unchanged. As a result, the pressure exerted by the head section 8 on the pressure indicator 9 is reduced, and when the pressure falls below the level required for the color change, i.e. in particular when the contact between the pressure indicator 9 and the head section 8 ceases, the color of the pressure indicator changes to blue. This corresponds to the clamped position of the connecting component 5 shown in FIG. 1.

The clamping force F causes the first element 1 and the second element 2 to be connected to one another in a non-positive manner. The clamping force F correlates with the elongation of the expansion region 21 of the connecting component 5. When the clamping force F decreases, the elongation of the expansion region 21 is also reduced.

If the clamping nuts 19 were to loosen and the clamping force F were to decrease as a result, the head section 8 of the pressure pin 7 would press against the pressure indicator 9 again, which would result in a color change of the piezochromic material. When checking the connection, the red color would immediately indicate that the clamping force F has decreased.

With suitable adjustment, detection may already be possible when the fastening nuts 19 are not completely loosened, i.e. at a time when loosening of the connection would not yet be detectable by manual inspection. The connection can then be strengthened again by tightening the fastening nuts 19. Preferably, tightening continues until the color change of the pressure indicator 9 again indicates sufficient clamping force F.

FIG. 2 shows a detailed view of the region A in FIG. 1, with the head section 8 and the cover element 9 shown in detail. The function has already been explained above, so the individual elements are not described in detail here.

FIG. 3 shows a schematic view of a second exemplary embodiment of the invention, wherein, compared to the first embodiment, also the first element 1 is a steel plate. Both the first element 1 and the second element 2 have the clearances 20, through which the connecting component 5 passes. The connecting component 5 has a projection 18 on the side of the first element 1 so that it cannot slip through the clearance 20. The application of the clamping force F is analogous to the first exemplary embodiment and will not be explained again here.

A further difference compared to the first exemplary embodiment is the way in which the pressure pin 7 is fastened in the recess 6 of the fastening bolt 5. A retaining means 14 in the form of a magnetic retaining element 16 is arranged at the lower end of the recess 6. The magnetic retaining element is a piece of a permanent magnet. The rest of the bolt 5 is made of stainless steel with an austenitic structure, so that it is not magnetic. The pressure pin 7 is made of ferromagnetic material and is therefore attracted by the magnetic retaining element 16. As a result, the pressure pin 7 is firmly positioned in the recess 6.

In an embodiment of the second exemplary embodiment not shown, the recess 6 may extend substantially over the full length of the connecting component 5. In this case, the pressure pin 7 may be fixed in the region of the projection 18 of the connecting component 5.

### LIST OF REFERENCE SIGNS

1 first element

2 second element

3 first clamping region

4 second clamping region

5 connecting component

6 recess

7 pressure pin

8 head section

9 pressure indicator

10 longitudinal extension direction

11 end region

12 cover element

13 protection plate

14 retaining means

15 polymer material

16 magnetic retaining element

17 tip

18 projection

19 clamping nut

20 clearance

21 expansion region

22 bandage

23 washer

24 view clearance

F clamping force

1. A mechanical connecting component for connecting a first element (1) to a second element (2) by exerting a clamping force (F), comprising a first clamping region (3) and a second clamping region (4), which is arranged at a distance from the first clamping region (3), wherein an expansion region (21) is arranged between the first clamping region (3) and the second clamping region (4), characterized
in that the connecting component can be moved from an unclamped position to a clamped position by exerting the clamping force (F), the length of the expansion region (21) increasing when the clamping force (F) is exerted,
in that an elongated recess (6) extends in the interior of the connecting component (5) at least in the expansion region (21),
in that a pressure pin (7) is arranged at least partially inside the recess (6), the pressure pin (7) comprising a head section (8), and the pressure pin (7) being connected to the connecting component at one end and not being connected to the connecting component at its other end, and
in that a pressure indicator (9) can be or is arranged in the region of the head section (8), the head section (8) being arranged in such a way as to exert pressure on the pressure indicator (9) in the unclamped position of the connecting component and to exert no pressure or a pressure which is reduced in comparison with the unclamped position on the pressure indicator (9) in the clamped position of the connecting component.

2. The connecting component according to claim 1, characterized in that the recess (6) extends from the first clamping region (3) to the second clamping region (4).

3. The connecting component according to claim 1 or 2, characterized in that the pressure pin (7) extends from the first clamping region (3) to the second clamping region (4), and in that one end of the pressure pin (7) is connected to the connecting component in the first clamping region (3) and is not connected to the connecting component in the second clamping region (4).

4. The connecting component according to one of claims 1 to 3, characterized in that the pressure indicator (9) comprises or is made of a piezochromic material.

5. The connecting component according to claim 4, characterized in that the piezochromic material is a piezochromic polymer composite, in particular comprising or consisting of a polymeric matrix material in which a piezochromic substance is contained.

6. The connecting component according to one of claims 1 to 5, characterized in that a cover element (12) is provided, which can be or is connected to an end region (11) of the connecting component,
wherein the pressure indicator (9) is arranged on the cover element (12), or
wherein the pressure indicator (9) is arranged on the head section (8) of the pressure pin (7).

7. The connecting component according to claim 6, characterized in that the cover element (12) is formed such that it is substantially flush with the connecting component (5).

8. The connecting component according to one of claims 1 to 7, characterized in that the cover element (12) has an at least partially transparent protective plate (13) on the side facing away from the head section (8).

9. The connecting component according to claim 8, characterized in that the protective plate (13) is made of an elastic material.

10. The connecting component according to one of claims 1 to 9, characterized in that the recess (6) is arranged parallel to the longitudinal extension direction (10) of the connecting component (5), preferably centrally along a central longitudinal axis of the connecting component (5).

11. The connecting component according to one of claims 1 to 10, characterized in that the pressure pin (7) is arranged parallel to the longitudinal extension direction (10) of the connecting component (5), preferably centrally along a central longitudinal axis of the connecting component (5).

12. The connecting component according to one of claims 1 to 11, characterized in that the pressure pin (7) is substantially rigidly and/or non-displaceably connected to the connecting component (5) at its end opposite the head section (8) by a retaining means (14).

13. The connecting component according to claim 12, characterized in that the retaining means (14) is a polymer material (15) in which the end opposite the head portion (8) of the pressure pin (7) is embedded and/or molded.

14. The connecting component according to claim 12, characterized in that the retaining means (14) is a magnetic retaining element (16), and in that the pressure pin (7) has a magnetic and/or a ferromagnetic material at least at its end opposite the head section (8).

15. The connecting component according to one of claims 1 to 14, characterized in that the pressure pin (7) has, at its end opposite the head portion (8), a conically tapering region, in particular a tip (17).

16. The connecting component according to one of claims 1 to 15, characterized in that the clamping force (F) can be or is generated by at least one clamping nut (19) arranged in the second clamping region (4).

17. The connecting component according to one of claims 1 to 16, characterized in that the first clamping region (3) can be or is rigidly connected to the first element (1) by bonding, welding and/or casting.

18. The connecting component according to one of claims 1 to 16, characterized in that the connecting component in the first clamping region (3) has a projection (18) and/or a fastening nut for positive connection to the first element (1), so that the connecting component can be partially inserted into a clearance (20) of the first element (1).

19. An arrangement comprising a connecting component according to one of claims 1 to 18 and a first element (1) and a second element (2), wherein a clearance (20) is provided in the first element (1) or in the second element (2), which is suitable for passing through and/or inserting the connecting component (5).

20. The arrangement according to claim 19, characterized in that the connecting component (5) is arranged to be freely movable at least in the expansion region (21) within the clearance (20).

21. A system comprising a connecting component according to one of claims 1 to 18 and a cover element (12), which is connected to the connecting component (5).
